(19) United States
(12) Patent Application Publication
(10) Pub. No.: US 2016/0021070 A1
(43) Pub. Date: Jan. 21, 2016

(54) SYSTEM AND METHOD FOR DATA-PROTECTION-COMPLIANT CAPTURE AND FORWARDING OF TELEMETRY DATA

(71) Applicant: AMV NETWORKS GMBH, Braunau am Inn - Ranshofen (AT)

(72) Inventor: Raimund WAGNER, Braunau am Inn - Ranshofen (AT)

(73) Assignee: AMV NETWORKS GMBH, Braunau am Inn - Ranshofen (AT)

(21) Appl. No.: 14/772,904

(22) PCT Filed: Mar. 6, 2014
(86) PCT No.: PCT/EP2014/000565

§ 371 Date: Sep. 4, 2015

(30) Foreign Application Priority Data
Mar. 6, 2013 (DE) 20 2013 002 107.1

(51) Int. Cl. H04L 29/06; G06F 21/60; G06F 21/62; H04W 84/18

(52) U.S. Cl. CPC H04L 63/0428; H04W 84/18; G06F 21/606; H04L 63/083; G06F 21/6254; H04L 63/102

(57) ABSTRACT

System for automated capture of telemetry data consisting of motion data and existing sensor data in transport means currently involved in the traffic for use to provide both services that benefit the public and services that are individual to single road users, comprising a data centre and a respective data capture/transmission device in the involved transport means, which communicate with one another via a wireless transmission path consisting of existing mobile radio networks and a secured internet protocol, characterized in that the data centre is situated in an organization that is independent of the integration point of the data capture/transmission devices and the service provider, has sole control over the captured telemetry data from the transport means and does not know the identity of the individual road users.

The invention relates to a system and method for the data-protection-compliant capture and forwarding of telemetry data, consisting of movement data and existing sensor data in transport means currently participating in the traffic situation for the related use in the provision of both services for the public benefit and individual services for individual road users, comprising a data center and respectively a data capture/communication device in the participating transport means, which communicate with one another via a wireless transfer path, consisting of existing mobile radio networks and a secure Internet protocol.

For the most diverse application situations that relate to traffic and/or benefit the public, it is already known on the one hand how to capture, to transfer and to process telemetry data from transport means. Even the use of wireless transfer paths, such as mobile radio networks or WLAN as well as Internet protocols on the basis of TCP/IP and Ethernet, secured by SSL encryption, is already general prior art.

On the other hand, in connection with this application, enormous data volumes are captured that are correlated with individual road users and therefore individual persons. Without an adequate anonymization of these data volumes, the protection of the personal rights of the road users pursuant to the Data Protection Act would not be sufficient or not even compliant. To the contrary, by the capture and long-term storage of diverse raw telemetry data, the possibility is opened and thus desires are awakened not only to use these for the originally intended application situations but also to employ or misuse them for applications situations originally not intended and possibly not agreed. This is due primarily to the fact that a service provider usually has direct control of the data capture/communication devices in the transport means and thus of the raw telemetry data.

The task of the present invention was to equip a system such as indicated hereinabove with appropriate functionality in order to permit the capture, transfer and related use of telemetry data from transport means both for the public benefit and for commercial services and simultaneously while doing so to protect the personal rights of the road users completely pursuant to the current Data Protection Act. This is achieved by withdrawing the control of the data capture/communication devices in the transport means from the service providers.

For the accomplishment of this task, the system is characterized according to the invention in that the data center is situated in an organization that is independent of the point of integration of the data capture/communication devices and the service provider, has sole control over the captured telemetry data from the transport means and does not know the identity of the individual road users. In this way the direct control of the data capture/communication devices and thus the control of the captured raw telemetry data is withdrawn from a service provider.

In the specific technical implementation, the data capture/communication device is an on-board unit for the retrofitting in motor vehicles, developed by a manufacturers' consortium under automotive viewpoints. Components of this on-board unit are a GPS module, a GSM transmitter module, a soldered SIM chip as mobile radio identification, a computing unit with volatile short-term memory (working memory/RAM) and nonvolatile program memory (EEPROM), a transceiver module for the connection to the vehicle data bus, additional discrete inputs and a power-supply unit. It must be emphasized that this on-board unit is not equipped with a unique identification during production. However, the system according to the invention is not limited to this kind of on-board unit. Other control devices or control devices already factory-set by the transport-means manufacturers may also be used as the data capture/communication means. In this case the data-transfer point (data interface) of the transport-means manufacturer, in which a correlation of the manufacturer-specific identification is established with the system-specific unique identification of the system according to the invention, is used as the point of integration.

Telemetry data in the present case are raw data (floating car data, FCD) that originate on the one hand purely from a subassembly for a geographic positioning system (GPS). In this connection, the time stamp of the positioning system, the geo position (longitude and latitude) and the unique identification of the data capture/communication device are used as reference values of a data record. On the other hand, different sensor data of the control devices present with factory settings in the transport means (extended floating car data xFCD), which are picked up from the standardized data bus (e.g. CAN bus) at a particular connection point, also exist in addition thereto. The nature and scope of these additional sensor data may vary more or less broadly depending on the model of the transport means. If a transport means is not equipped with its own sensors or a standardized data bus, the telemetry data are restricted purely to those of the geographic positioning system.

According to an advantageous embodiment of the invention, it is provided that the necessary raw telemetry data both for any public benefit and for provision of individual service are assembled as data packets and thus are defined in the data center, so that individual service providers receive only the data necessary for the provision of their respective service. Because of this feature, the usability of the data packets transferred to the service providers is restricted to the effect that they can be used exclusively for the originally conceived and individually agreed application situations.

Within the scope of the invention, data packets are to be understood as a combination of selected telemetry data together with reference data. In general, the time stamps of the data collection of a data record are always valid as reference data. Further reference data depend on whether the data packets are not correlatable or are correlatable with an individual transport means (and therefore with a person: the holder or user). FCD or xFCD, which are necessary for a particular application situation, are valid as additional telemetry data. Consequently, for each application situation, there is a data packet exactly matched thereto—i.e. an individual compilation of reference and user data. The data protection principle of data minimization is respected with this type of “filtering”.

The data center receives the telemetry data and filters them, in the case of commercial service providers on the basis of granted permissions for the data forwarding by disclosure of permission. keys, correlated data packets to service providers, and in the case of organizations serving the public benefit additionally on the basis of correlated geographic observation zones. In the process, the data center makes use of an IT system, consisting of network infrastructure, application servers, database systems for the control data of the filtering and data forwarding as well as monitoring systems for the assurance of the smooth and interruption-free operation of the overall system.

Advantageously, it is additionally provided that a data capture/communication device, prior to integration into the system described here, does not have any unique identification relevant for this but instead a unique identification, which is made known exclusively to the road user together with a permission key for the accessing of possible individual services by using a transfer form protected from view, is correlated with it only upon integration into the system. This correlation may take place both directly in the data capture/communication device and at another location, whereby in each case it must be ensured that the raw telemetry data from the data capture/communication devices arrive in the data center together with the unique identification. In this way the identification of individual road users by tracing back via manufacture, delivery and installation of the data capture/communication devices is prevented.

The unique identification is, for example, an integral number, with which a data capture/communication device can be uniquely identified as soon as it has been assigned thereto. The allocation takes place according to the random principle, in which it is allocated not already at the factory during the manufacture of the data capture/communication device but instead exists only in a secure transfer form before integration and activation in a transport means. Data capture/communication devices and secure transfer forms are produced and delivered independently of one another in different batches and package sizes. Thus it is impossible, before integration of a data capture/communication device into a transport means, to predict which unique identification is ever saved in which data capture/communication device and in which transport means this is installed.

In a specific technical implementation, a permission key may be, for example, a 4-digit numerical PIN, which is generated according to the random number principle and correlated with the unique identifications in the transfer form. This correlation is additionally stored in protected form in the data center. The permission key is needed fox the authorization of commercial service providers, whereby they are permitted to call up correlatable data packets of individual road users from the data center. During hiring of a commercial service provider by a road user for the provision of an individual service, the road user issues the commercial service provider a consent declaration for it to call up data packets correlatable to it from the data center. This takes place by disclosure of the unique identification and of the associated permission key. The unique identification alone would not be sufficient, since thereby the commercial service provider, by “guessing”, could gain access to further correlatable data packets to which it does not have rights. A decisive advantage in this respect is that the telemetry data do not have to be laboriously anonymized first, since they are most extensively neutralized (pseudonymized) in advance by the nature of the system.

In order to prevent the point of integration also from gaining knowledge of the allocated unique identification during integration of a previously unconsidered data capture/communication device, it is provided according to a further advantageous embodiment of the invention that an arbitrary unsorted number of unique identifications in a transfer form protected from view is transferred by the data center to the point of integration, whereupon this selects one arbitrarily for the integration of data capture/communication devices into the system and correlates this by means of an activation device of the data capture/communication device while using the encrypted identification present on the outside of the transfer form.

The integration device is a tool or means for the integration of data capture/communication devices into the system. In the specific case it may consist of a programming adapter (hardware), which on the one hand is connected via a USB interface with a PC and on the other hand can be connected via, for example, a 1-wire interface with the data capture/communication device. A further component is a computer program, which on the one hand can communicate via the programming adapter with the data capture/communication device and on the other hand via an encrypted Internet connection (secure socket layer/SSL) with the data center. A graphical interface functions as the user interface. With the integration device it is defined in which kind of transport means model the data capture/communication device will be integrated and which unique identification will be resident thereon. This correlation is finally transferred to the data center.

In other instances of the invention, the integration device may be a correlation data interface of a vehicle manufacturer, if data capture/communication devices installed by the vehicle manufacturer at the factory are to be used. In this way the correlation of the identification preferably takes place by using the random principle, which provides that the data capture devices are not provided with any factory-set unique identifications but instead these are generated and delivered separately from the data capture devices. At the point of integration, an arbitrary data capture device and an arbitrary transfer form containing unique identification are taken from the pool in the store of the point of integration and used for an integration. The unique identification is secured by the transfer form from the view of unauthorized parties.

An additional protection of the personal rights of the road users from the service providers working for the public benefit is achieved in connection with an embodiment of the system according to the invention by the fact that, out of the telemetry data received from the transport means in the data center, the unique identification of the individual data capture/communication devices is replaced, before provision to organizations benefiting the public, by merely a stretch identification, which changes for each new coherent path stretch. In this way the need of services benefiting the public for coherent route information is satisfied without providing, by virtue of the coherence of several stretches of the route, data material that would be suitable for the heuristic evaluation of behavior patterns and thus consequentially for the identification of road users.

A stretch identification may be, for example, an internal number, which is assigned to individual telemetry data records that belong to a coherent movement (e.g. travel) of a transport means. By definition, such a coherent movement is bounded by the departure (e.g. beginning of travel) and stoppage of a transport means. As soon as the transport means resumes movement (e.g. new travel), a new stretch identification is allocated, so that no coherence exists any longer between the individual coherent movements of a single transport means.

Within the scope of the invention, data packets are not correlatable to an individual transport means (and thus to an individual road user—the holder or user) if the reference data of an individual data record consist merely of the time stamp of the data collection. In application situations for the public benefit, in which the telemetry data of individual road users is not permitted to be correlatable, the requirement exists in isolation that data records of a coherent movement of the transport means must be in relation to one another (chaining) so that the service for the public benefit is possible. In these cases, a so-called stretch identification (e.g. travel ID), which expires after the end of the movement and is renewed upon redeparture of the transport means, is generated as an additional reference. As an example, the new stretch identification for this purpose is taken from a counter that is used for all transport means participating in the system. In this way the requirements of these special services can be satisfied without enabling the creation of so-called movement profiles with these data packets, for which purpose the correlation of several coherent movements of a particular transport means would be necessary. The addition of a stretch identification as a further reference takes place as needed.

Above and beyond this, the captured telemetry data of the transport means can be advantageously filtered in the data center, before provision to organizations for the public benefit, on the basis of geographic zones defined by the data center, in order, besides the anonymity, to reduce the data volumes to be transferred and thus to be processed.

Geographic observation zones may be geographic regions that describe one or more districts on the basis of several geo coordinates (longitude and latitude according to the World Geodetic System 1984/WGS84). For this purpose a special filter is controlled in order that organizations for the public benefit receive only non-correlatable data packets that are also relevant for them. Since these data packets are not supposed to be correlatable to individual road users for this type of service providers and in particular will be evaluated statistically, usually only data of certain districts are queried here. This procedure is used to satisfy the data protection principle of data minimization. As an example, geographic observation zones consist of a series of geo coordinates (latitude and longitude) that describe a geographic district. On the basis of trigonometric comparison algorithms, it may be ascertained whether a telemetry data record with its position data originated inside or outside such an observation zone. If its origin is located inside, it is forwarded. If it is located outside, it may be discarded, for example.

Since the data packets to be transmitted must be equipped with the unique identification of the data capture/communication device for related use by commercial service providers, they are advantageously prepared only if the commercial service provider has been granted the consent by the road user beforehand, which it verifies to the data center by presentation of the unique identification of the data capture/communication device and a permission key. In this way it is ensured that the service provider does not arbitrarily retrieve data from the data center in such a way that the road user in question does not have awareness thereof or has not declared his or her consent.

The road user obtains the greatest possible transparency about the data deliveries by the embodiment of the system according to the invention by the fact that the data center provides a web server with graphical user interface, via which a road user is able, by use of an arbitrary Internet access and by authorization with his or her unique identification and the associated password, to check at any time which data packets consisting of the telemetry data of his or her transport means are currently being provided by the data center and which service providers are retrieving them. The access data are located in the transfer form, which is protected from view and which is handed out to the road user during integration of his or her data capture/communication device by the point of integration. This enables the road user to control the compliance with the contractual agreements between him or her and the service providers with respect to the calling up of data from the data center.

In a preferred embodiment of the invention, each participating road user obtains, by means of the secure transfer form, access data about the web portal of the data center, in such a way that the data center does not have to gain knowledge of the identity of the participating road user. After logging into the web portal, the road user is able to view a list of the commercial service providers which are currently receiving correlatable data packets from his or her transport means. These data subscriptions are equipped with an intervention function, with which the road user is able in the web portal to postpone data delivery of individual data subscriptions until later. Only he or she alone is able to reactivate the data delivery again. The prohibitions are resident, for example, in an SQL database of the data center and are considered for the forwarding of incoming telemetry data.

The organizational separation of the units of the system is implemented technically by several individual features. For example, it is prevented by network-related and program-related precautions that telemetry data of a road user are communicated to unauthorized service providers or users without his or her declaration of consent, that the data center gains knowledge of the identity of the road user or of his or her individual transport means, that the points of integration gain knowledge of the unique identification of the data capture/communication devices, or that vehicle manufacturers, manufacturers of data capture/communication devices, operators of data transfer paths (e.g. mobile radio operators), etc. gain access to the collected telemetry data (e.g. by use of firewalls, encrypted network connections, authentication and authorization systems). The separation may also take place by the use of different network infrastructures and system components in all participating organization units, which by virtue of the lack of knowledge of access rights (user names, passwords, etc.) also do not have any possibilities whatsoever of access to the respective other systems.

In the description hereinafter, the invention will be explained in more detail on the basis of a preferred exemplary embodiment, which is also illustrated in the attached drawings, wherein:

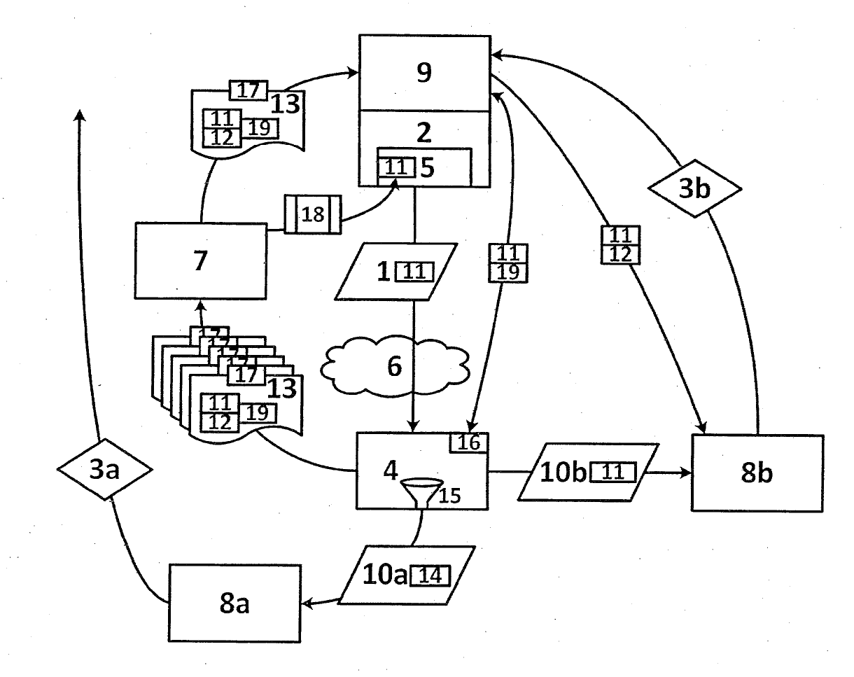

FIG. 1 shows a system according to the invention in a schematic diagram.

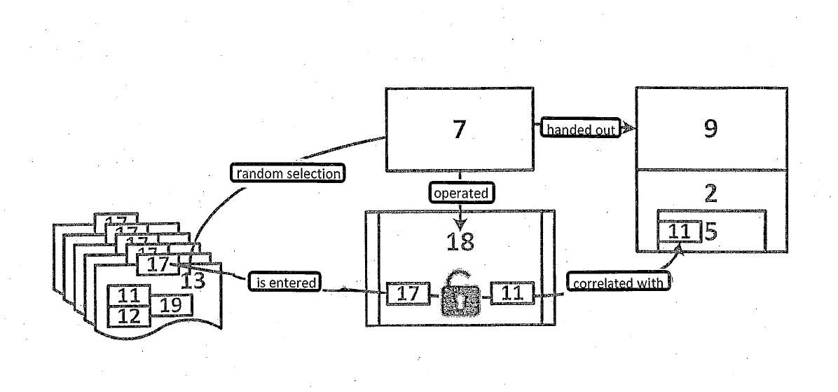

FIG. 2 describes the process of integration of data capture/communication devices into transport means and

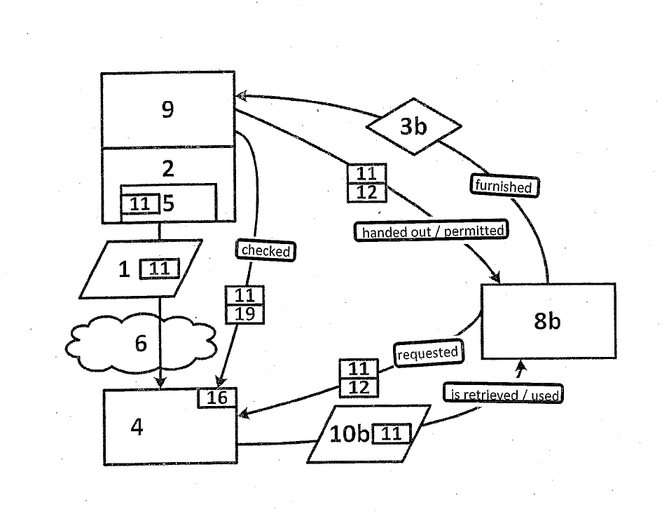

FIG. 3 shows the process of permission for commercial service providers with review by the road user.

The system illustrated in FIG. 1 for the automated capture of telemetry data in transport means comprises, for example, a transport means [2], equipped with a data capture/communication device [5], which transfers telemetry data [1] over a wireless transfer path [6], consisting of existing mobile radio networks and a secure Internet protocol (preferably TCP/IP and Ethernet), to a data center [4]. The data capture/communication device [5] was registered in the system beforehand by a point of integration [7] with assistance of an integration device [18] by assignment of a unique identification [11]. For this purpose the point of integration [7] selects an arbitrary unique identification [11], which was provided to it by the data center [4] via several transfer forms [13] protected from view. This transfer form [13] contains a unique identification [11] not visible to the point of integration [7], as well as a permission key [12]. For integration, the encrypted identification [17] is affixed on the Outside of the transfer form [13] so as to be visible to the point of integration [7]. An inference from the encrypted identification [17] back to the unique identification [11] is possible exclusively in the data center [4]. Finally, the transfer form [13] is handed out to the road user [9], after which he or she has sole knowledge of the unique identification [11] assigned to him or her.

On the output side of the system there is connected on the one hand, for example, an organization [8a] for the public benefit, which obtains from the data center [4], for the provision of services [3a] for the public benefit, non-correlatable data packets [10a], which have been filtered out of the telemetry data [1] on the basis of geographic observation zones [15] and in which the unique identification [11] has been replaced beforehand by a stretch identification [14]. Also connected to the system on the other hand, for example, is a commercial service provider [8b] which, for the provision of an individual service [3b], obtains correlatable data packets [10b] with the unique identification [11], for the reception of which it obtains permission from the road user [9] beforehand by the granting of the unique identification [11] together with a permission key [12]. The road user [9] is able to control the compliance with this permission via a web server [16], which is provided by the data center [4].

FIG. 2 shows, for example, the process of integration of a new data acquisition/transmission device [5] that has not yet been registered in the system by a point of integration [7], which selects an arbitrary transfer form [13], on the outside of which an encrypted identification [17] is visibly affixed. By entry of the encrypted identification [17] into an integration device [18], the identification is encrypted and assigned, in a form not visible for the point of integration [7], to the new data capture/communication device [5]. Finally, the as yet unopened transfer form [13] is handed out to the road user [9], whereby he or she has the sole knowledge of the unique identification [11] allocated to him or her, of the permission key [12] and of his or her password [19].

FIG. 3 shows in detail, as an example, how the process of permission of a commercial service provider [8b] by the road user [9] takes place. In the course of hiring of the commercial service provider [8b] by the road user [9], he or she authorizes the commercial service provider [8b], by disclosure of his or her unique identification [11] together with the permission key [12], to retrieve data packets [10b], which contain telemetry. data [1] from the transport means [2] of the road user [9], from the data center [4]. As an example, this takes place here by the fact that the commercial service provider [8b] in turn requests the correlatable data packets [10b] from the data center [4] by presentation of the unique identification [11] together with the permission key [12]. By the subsequent receipt of the correlatable data packets [10b] together with the unique identification [11], the commercial service provider [8a] is then able to furnish its individual service [3b] to the road user [9].

### REFERENCE NUMERAL LIST

1 Telemetry data, consisting of movement data and existing sensor data in transport means [2] currently participating in the traffic situation
2 Transport means currently participating in the traffic situation
3 Service
3a Service for the public benefit
3b Individual service for individual road users [9]
4 Data center
5 Data capture/communication device in participating transport means [2]
6 Wireless transfer path, consisting of existing mobile radio networks and a secure Internet protocol
7 Point of integration (organization unit that integrates an independent data capture/communication device [5] into the network)
8 Service provider
8 Organization for the public benefit
8b Commercial service provider
9 Road user (simultaneously owner of the transport means [2])
10 Data packets
10a Non-correlatable data packets
10b Correlatable data packets
11 Unique identification (in unencrypted status)
12 Permission key
13 Transfer form, which protects the contents from the view, is closed, sealed and to be opened only by the road user [9]
14 Stretch identification
15 Geographic observation zones
16 Web server for graphical user interface
17 Encrypted identification (unique identification [11] in encrypted status]
18 Integration device (tool or means for integration of data capture/communication device [5] into the network)
19 Password

1. System for the automated capture of telemetry data (1) consisting of movement data and existing sensor data in transport means (2) currently participating in the traffic situation for the provision of services (3b), comprising:
at least one transport means (2) with a data capture/communication device (5), which is disposed in the transport means (2);
a data center (4);
an at least partly wireless network (6) for the transfer of the telemetry data (1) from the transport means (2) to the data center (4); and
a service provider (8b), which furnishes a service on the basis of the telemetry data (10b) communicated to it;
wherein
the data center (4) and the service provider (8b) constitute separate organization units and a data forwarding of telemetry data (10b) from the data center (4) to the service provider (8b) takes place only by communication of a permission key (12) from the road user (9) to the service provider (8b) and from the service provider (8b) to the data center (4).

2. System according to claim 1, wherein the data center (4) is designed in such a way that it makes data packets (10b) of a predetermined selection of telemetry data (1) available to a particular service provider (8b) when the permission key (12) is communicated by the service provider (8b) to the data center (4).

3. System for the automated capture of telemetry data (1) comprising movement data and existing sensor data in transport means (2) currently participating in the traffic situation for the provision of services (3a) for the public benefit, comprising:
at least one transport means (2) with a data capture/communication device (5), which is disposed in the transport means (2);
a data center (4);
an at least partly wireless network (6) for the transfer of the telemetry data (1) from the transport means (2) to the data center (4); and
a service provider (8a), which furnishes a service (3a) for the public benefit on the basis of the telemetry data (10a) communicated to it;
wherein
the data center (4) and the service provider (8a) constitute separate organization units and the data center (4) is provided with means for the filtering and/or anonymizing of the telemetry data (1) in the form of filtered and anonymized data (10a) for the forwarding to the service provider (8a) for the public benefit.

4. System according to claim 3, wherein the means for the filtering and/or anonymizing of the telemetry data (1) replaces a unique identification (11) that the data center (4) has received together with the telemetry data (1) of a particular data capture/communication device (5) by a stretch identification (14), which is changed for each new coherent path stretch, before provision to the service provider (8a) for the public benefit.

5. System according to claim 3, wherein the means for the filtering and/or anonymizing of the telemetry data (1) is provided with a device for the filtering on the basis of defined geographic observation zones (15).

6. System according to claim 1, wherein the data capture/communication device (5) is designed in such a way that telemetry data (1) from the data capture/communication device (5) to the data center (4) are communicated with a unique identification (11) of a data capture/communication device (5) to the data center (4).

7. System according to claim 1, wherein the system is provided with a point of integration (7) for the correlation of a unique identification (11) with a data capture/communication device (5).

8. System according to claim 1, wherein the data center has sole control over the captured telemetry data (1) from the transport means (2) and the identity of the individual road users (9) is not known to it.

9. System according to claim 1, wherein the data center (4) assembles the raw telemetry data (1) necessary for service providers (8) as data packets (10) and defines these in such a way that individual service providers (8) obtain only the data that are necessary for the furnishing of their respective service (3).

10. System for the capture processing and transmission of telemetry data, especially system according to claim 1, wherein the system is provided with a point of integration (7), which is provided with a device for the reception of an arbitrary unsorted number of unique identifications (11) from the data center (4), which is transferred in a transfer form (13) protected from view, wherein the point of integration (7) is further provided with a device for the integration of data capture/communication devices (5) into the system, which selects an arbitrary unique identification (11) and correlates it and places it in operation by means of an integration device (18) of the data capture/communication device (5) by use of the encrypted identification (17) located on the outside of the transfer form (13), without gaining knowledge of the unique identification (11) while doing so.

11. System according to claim 1, wherein the data center (4) comprises a web server (16) with graphical user interface, via which a road user (9) is able to check at any time by use of an arbitrary Internet access and by authorization with his or her unique identification (11) and the associated password (19) which data packets (10) consisting of the telemetry data (1) of his or her transport means (2) are currently being provided by the data center (4) and which service providers (8) are retrieving them.

12. Method for the automated capture of telemetry data (1) comprising movement data and existing sensor data in transport means (2) participating in the current traffic situation for the provision of services (3b), comprising the steps:
a) Capture of telemetry data (1) in a vehicle (2);
b) Communication of the telemetry data (1) by a data capture/communication device (5) to a data center (4);
c) Communication of a data packet (10b) based on the telemetry data (1) to a service provider (8b), when this requests the data record (10b) by means of a permission key (12) obtained from the road user; and
d) Furnishing of an individual service (3b) by the service provider (8b) to the road user (9).

13. Method according to claim 12, wherein the telemetry data (1) are communicated in the method step b) with a unique identification (11) of the data capture/communication device (5).

14. Method according claim 12, wherein the road user requests a service (3b) by communication of a permission key (12), especially in conjunction with a unit identification (11), to the service provider (8b).

15. Method for the automated capture of telemetry data (1) comprising movement data and existing sensor data in transport means (2) currently participating in the traffic situation for the provision of services (3a) for the public benefit, comprising the steps:
a) Capture of telemetry data (1) in a vehicle (2);
b) Communication of the telemetry data (1) by a data capture/communication device (5) to a data center (4);
c) Filtering and/or anonymizing of the telemetry data (1) for the generation of filtered and/or anonymized data (10a) for the forwarding to the service provider (8a);
d) Communication of the filtered and/or anonymized data (10a) based on the telemetry data (1) to a service provider (8a); and
e) Furnishing of a service (3a) for the public benefit by the service provider (8a).

16. Method according to claim 15, wherein the filtered and/or anonymized data (10a) are communicated with a stretch identification (14) to the service provider (8a).

17. Method for the automated capture of telemetry data (1) comprising movement data and existing sensor data in transport means (2) currently participating in the traffic situation for the provision of services (3a), especially according claim 12, wherein, during integration into a system for the implementation of the method, there is correlated, with a data capture/communication device (5), a unique identification (11), which is known exclusively to the road user (9) with whom the data capture/communication device (5) is correlated, and a permission key (12) for the demand for services (3b) is correlated, wherein at least the correlation of the identification (11) takes place by use of a transfer form (13), which is protected from view, closed, sealed and to be opened only by the road user (9).
